(19) United States
(12) Patent Application Publication
(10) Pub. No.: US 2004/0217109 A1
(43) Pub. Date: Nov. 4, 2004

(54) Electric baking pan

(76) Inventor: Kuei Tang Chang, Taipei (TW)

Correspondence Address: TSENG, YI WEN, 509 ROOSEVELT BLVD. #D306, FALLS CHURCH, VA, 22044, US

(21) Appl. No.: 10/427,934

(22) Filed: May 2, 2003

(51) Int. Cl. H05B 3/06

(52) U.S. Cl. 219/525; 219/524

(57) ABSTRACT

An electric baking pan, having a first base and a second base. The first base has a first shell, a first handle connected to one side of the first shell, a first baking plate, at least one snapping device installed in the first handle to engage with the first baking plate, a pair of pivot plugs disposed at two lateral ends of the first shell, and a first heat isolating plate disposed in the first shell, the first heat isolating plate includes a first heating element to heat up the first baking plate. The second base has a second shell, a second handle connected to one side of the second shell, a second baking plate, at least one snapping device installed in the first handle to engage with the first baking plate, a pair of pivot sockets disposed at two lateral ends of the second shell allowing the pivot plugs slidably installed therein, and a second heat isolating plate disposed in the second shell, the second heat isolating plate includes a second heating element to heat up the second baking plate. The first base can be placed on top of, elevated over, perpendicular to, or extending in parallel with the second base.

### BACKGROUND OF THE INVENTION

The present invention relates to an electric baking pan and, more particularly, the present invention relates to an electric baking appliance used to bake food for household application.

Due to the invention and development of electricity, tools used in our daily lives are continuously improved. The invention of electric backing pan provides the convenience for baking food, and replaces the conventional way to bake food by fire. The electric backing pan is safer to use and does not occupy a large space.

The conventional baking pad comprises a top baking plate 1′, a bottom baking plate 5′ mounted to interior surfaces of a top enclosure 2′ and a bottom enclosure 6′, respectively. The top and bottom baking plates 1′ and 5′ each comprises a plurality of ridges 11′ 51′, respectively. A heating element for providing the heat source is installed in the bottom enclosure 6′. By disposing food on the bottom baking plate 5′, the food is baked thereby. When the food is baked, the top enclosure 2′ is placed over the bottom enclosure 5′ to prevent the heat from dissipating out of the baking pan.

However, when the top enclosure 2′ lids over the bottom enclosure 5′, the space and height for accommodating the food is very limited. Therefore, the application of this kind of baking pan is limited by the thickness of food. On the other hand, the food such as hamburger is easily deformed for being clamped by the top and bottom baking plate 1′ and 5′ to affect the appearance and taste thereof. Further, the food may be stuck on the top and bottom plates 1′ and 5′ and in contact with the portion directly over the heating element to cause the food over-burnt. In addition, as the top and bottom baking plates 1′ and 5′ are permanently mounted to the top and bottom enclosures 2′ and 6′ respectively, it is not easy to thoroughly clean the baking pan, and the hygiene problem occurs.

Therefore, there exists a need to improve the electric baking pan, so as to provide an electric baking pan with an adjustable space for disposing food and a removable baking plate for cleaning.

### BRIEF SUMMARY OF THE INVENTION

The present invention provides an electric baking pan that comprises a pivot mechanism to increase the baking space of the electric baking pan, such that deformation of the food can be prevented.

The present invention further provides an electric baking pan that comprises a snapping device to remove the baking plate from the electric baking pan. Therefore, the user can easily clean the baking plate and replace the baking plate by other backing plates with various patterns.

The electric baking pan provided by the present invention comprises a first base which further comprises a first shell, a first handle connected to one end of the first shell, a first baking plate, at least one snapping device installed in the first handle to connect and fix the first baking plate, and at least a pair of pivot plugs installed at two lateral ends of the first shell. The first base further comprises a first isolating board disposed in the first shell. The first isolating board has a first heating element for heating the first baking plate.

The electric baking pan further comprises a second base. The second base comprises a second shell, a second handle connected to one side of the second shell, a second baking plate, at least one snapping device installed in the second handle to connect the second baking plate, and a pair of pivot sockets at two lateral ends of the second enclosure, such that the pivot plugs can be slidably and pivotally mounted thereto. The electric pan further comprises a second isolating board installed in the second shell. The second isolating board comprises a heating element for heating the second baking plate. The first base can be placed over the second base in four positions, including clamping thereover, elevated thereover, perpendicular thereto and parallel thereto.

### BRIEF DESCRIPTION OF THE DRAWINGS

These, as well as other features of the present invention, will become apparent upon reference to the drawings wherein:

FIG. 1 shows a perspective view of a conventional electric baking pan;

FIG. 2 shows an exploded view of an electric baking pan provided by the present invention;

FIG. 3 shows the rear exploded view of the electric baking pan;

FIG. 4 is a perspective view showing the first base placed over the second base;

FIG. 5 is a schematic view showing the first base placed over the second base;

FIG. 6 is a perspective view showing the first base placed over the second base;

FIG. 7 is a schematic view showing the first base placed over the second base;

FIG. 8 is a perspective view showing the first base extended in parallel with the second base;

FIG. 9 is a schematic view showing the first base extended in parallel with the second base;

FIG. 10 is a perspective view showing the first base elevated over the second base;

FIG. 11 is a schematic view showing the first base elevated over the second base;

FIG. 12 is a perspective view showing the snapping device of the second base;

FIG. 12A shows an enlarged view of part A of FIG. 12;

FIG. 13 shows another embodiment of the present invention;

FIG. 14 is an exploded view showing the rear view of the first base;

FIG. 15 is an exploded view showing the rear view of the second base;

FIG. 16 shows the detachable breakfast plate of the electric baking pan; and

FIG. 17 shows the smokeless detachable barbecue plate of the electric baking pan.

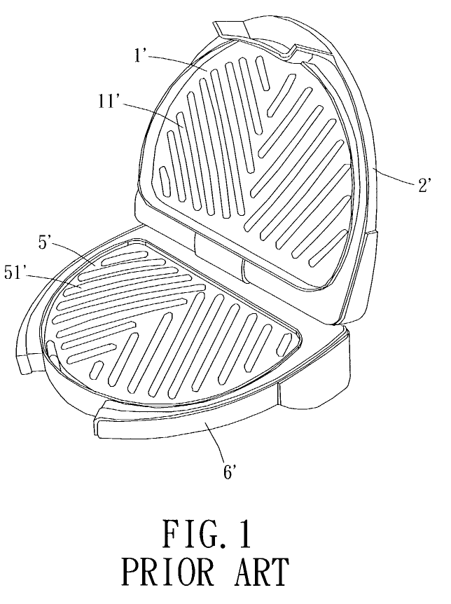

### DETAILED DESCRIPTION OF THE INVENTION

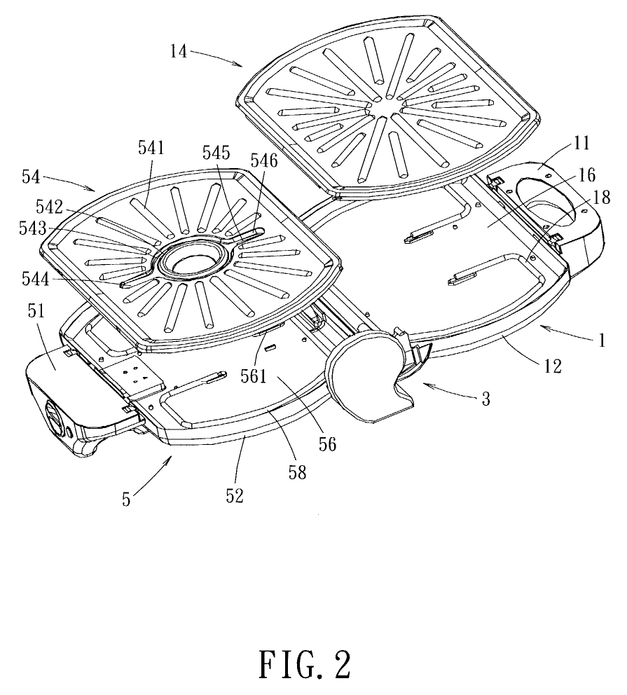

Referring to FIG. 2, an exploded view of an electric baking pan provided by the present invention is illustrated. The electric baking pan comprises a first base 1 and a second base 5 connected to the first base 1.

The first base 1 comprises a first shell 12, a first baking plate 14, a first handle 11 connected to a front end of the first shell 12, a pair of pivot plugs 3 located at two lateral ends of the first shell 12, and a first heat isolating plate 16 installed in the first shell 12. One the first heat isolating plate 16, a first heating element 18 is installed to provide heat to the first baking plate 14.

The second base 2 comprises a second shell 52, a second baking plate 54, a second handle 51 connected to a front end of the second shell 52, a pair of pivot sockets 7 located at two lateral ends of the second shell 52, and a second heat isolating plate 56 installed in the second shell 52. A second heating element 58 is further installed on the second heat isolating plate 56 for heating the second baking plate 54.

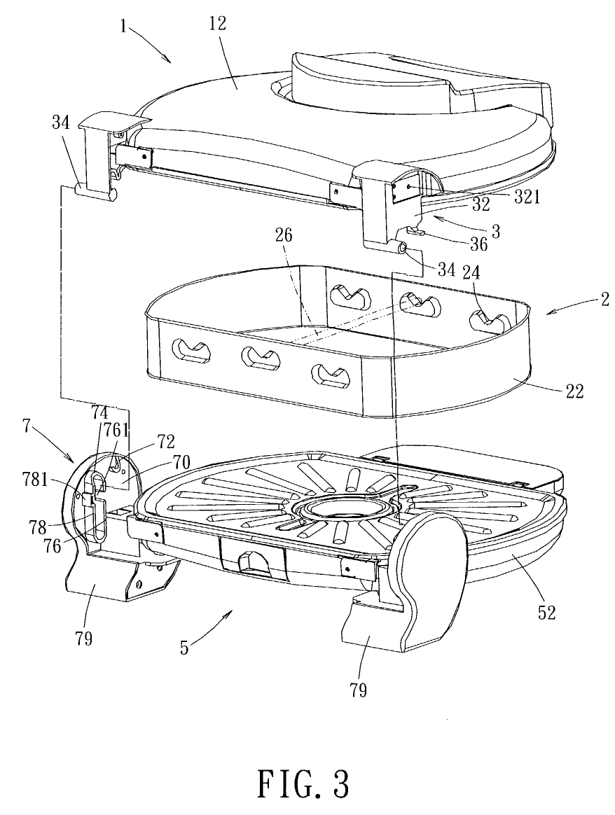

FIG. 3 shows the exploded rear view of the electric baking pan. The pivot plugs 3 are slidably mounted to the pivot sockets 7. Each of the pivot plugs 3 includes a panel 32 connected to the lateral end of the first shell 12, a pivot pin 34, and a locating bearing 36. The pivot pin 34 and the positioning lever 36 are located at the bottom of the panel 32. In this embodiment, the panel 32 is engaged with the first shell 12 via the threaded bores 32. The pivot sockets 7 each has a substrate 70 connected to the lateral ends of the second shell 52, a U-shaped lug 72, and an elongate ring 74. The U-shaped lug 72 and the elongate ring 72 are mounted on the substrate 70. The elongate ring 74 includes a front panel 76 and a rear panel 78. The front panel 76 has an opening, while the rear panel 78 has a slot 781 aligned with the opening 761. The pivots 34 of the pivot plugs 3 are slidably mounted in the elongate ring 74. The positioning lever 36 is slidably disposed in the slot 781 of the elongate ring 74, or extending through the opening 761 and seated on the U-shaped lug 72. An external cover 79 can be used to cover each pivot sockets 7 to provide protection and aesthetic effect.

In the present invention, depending on the operation convenience for the user, the first base 1 and second base 5 can be connected in at least four different ways as described as follows.

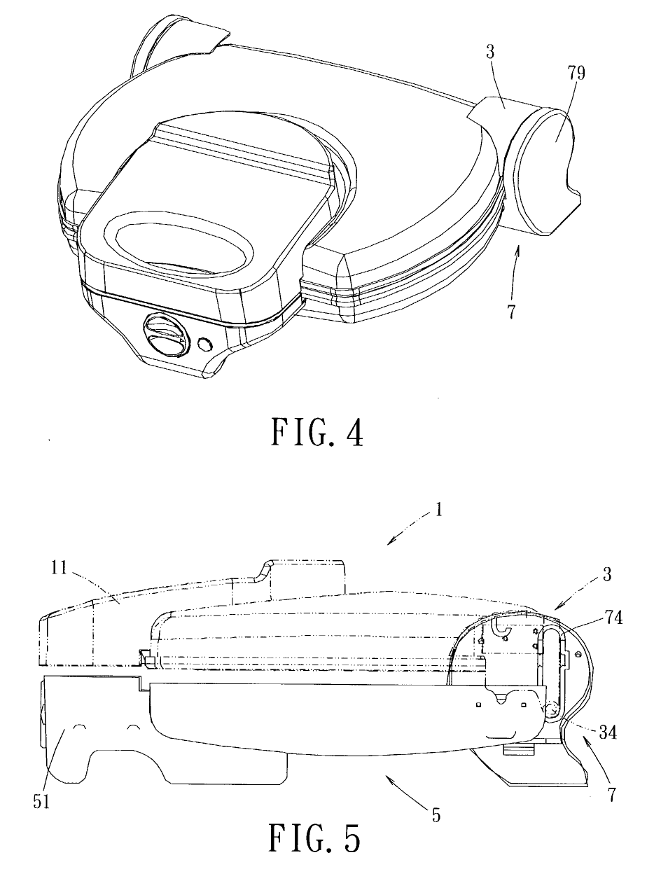

Referring to FIGS. 4 and 5, a schematic view showing the first base 1 placed over the second base 2 shown is illustrated. The pivot pin 34 of the pivot socket 3 is located at the bottom of the elongate ring 74 and rotate until the first handle 11 of the first base 1 is located on the second handle 51 of the second base 5.

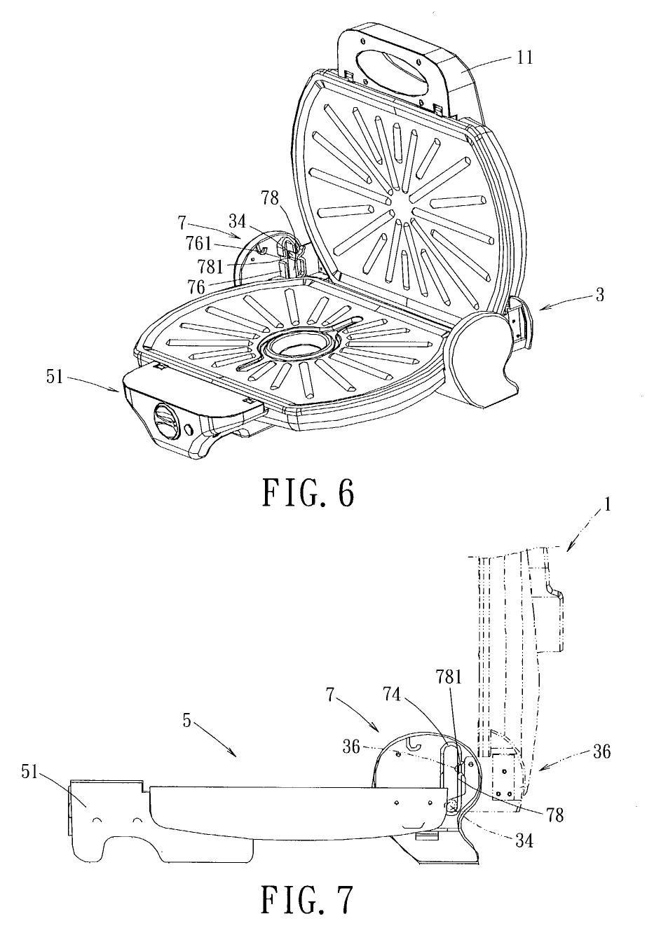

Referring to FIGS. 6 and 7, a schematic view showing the first base 1 perpendicular to the second base 5 is illustrated. The pivot pin 34 of the pivot socket 3 is located at the bottom of the elongate ring 74 to flip the first base 1 upwardly. Thereby, the positioning lever 36 of the pivot socket 3 extending through the opening 761 of the front panel 76 of the elongate ring 74 and snapped into the slot 781 of the elongate ring 74. Thereby, the first base 1 is disposed perpendicular to the second seat 5.

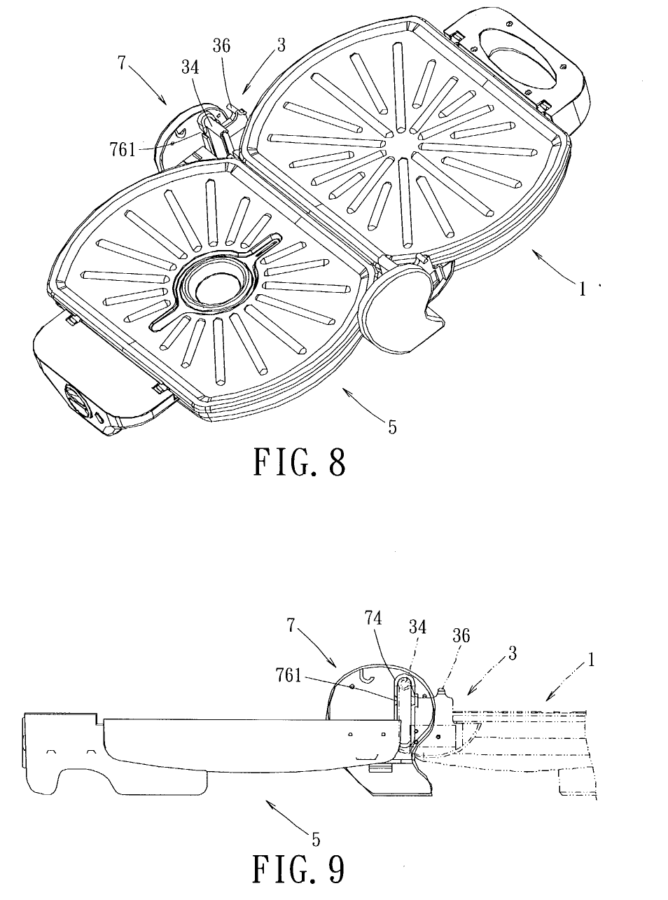

Referring to FIGS. 8 and 9, a schematic view showing the first base 1 extending in parallel with the second base 5 is illustrated. Following FIG. 7, the first base 1 is inclined forward allowing the positioning lever 36 sliding away from the slot 761 of the elongate ring 74. The first base 1 is elevated until the pivot pin 34 of the pivot socket 3 is raised to the top of the elongate ring 74. The first base 1 is then flipped outwardly until the bottom end of thereof is level to the bottom of the second base 5.

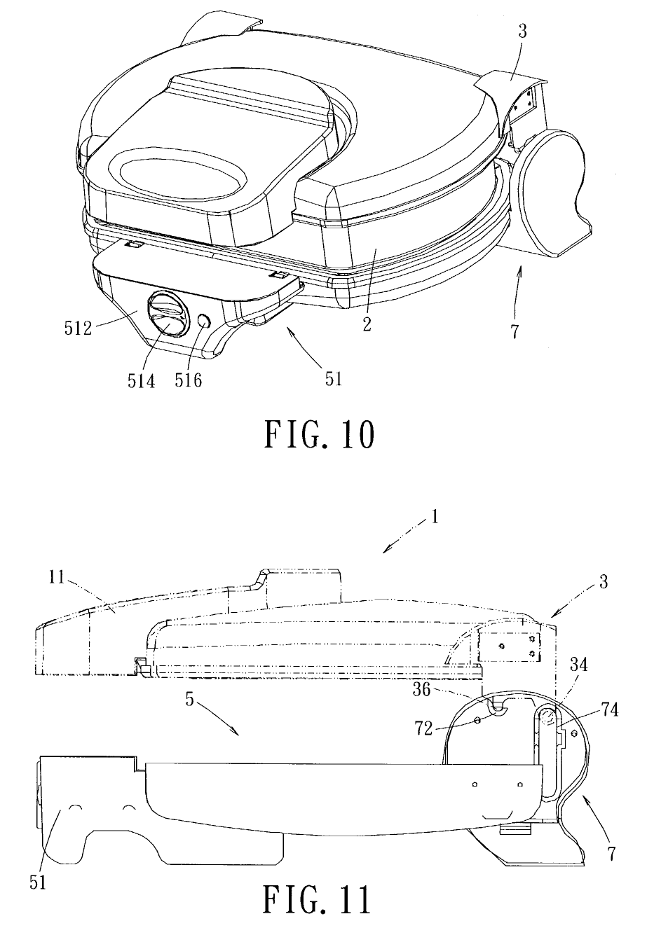

Referring to FIGS. 10 and 11, a schematic view showing the first base 1 elevated over the second base 5 is illustrated. The pivot pin 34 of the first base 1 is disposed at the top of the elongate ring 74, and the first base 1 is flipped forward to dispose the positioning lever 36 on the U-shaped lug 72. Therefore, the first base 1 is elevated and held over the second base 5.

Referring to FIG. 3, when the first base 1 is elevated over the second base 5, a ring 2 can be inserted between the first base 1 and the second base 5 to provide an enclosed baking space. Thereby, the baking function is attained, while the food will not be deformed by the clamping effect of the first and second bases 1 and 5. The ring 2 preferably includes a circular wall 22 made of metal material. A plurality of slots or openings 24 can also be formed on the circular wall 22 for holding skewers.

The operation of the electric baking pan is shown in FIG. 10. The vertical side of the second handle 51 has the push buttons 514 and 516 for switching and controlling the electric pan.

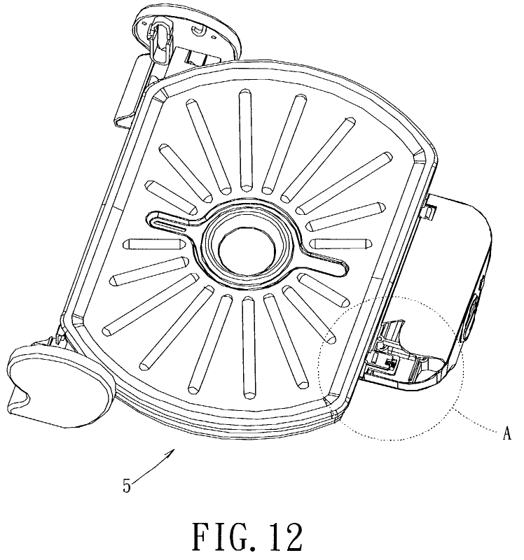

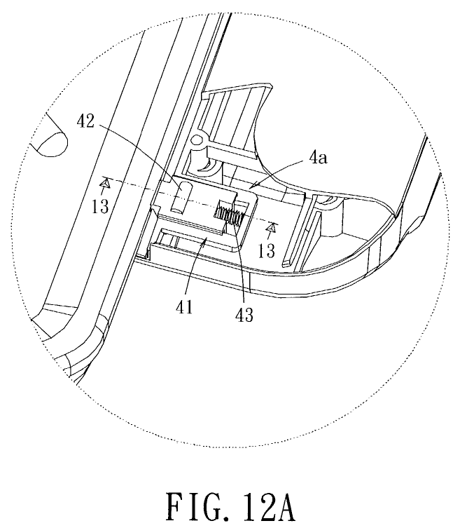

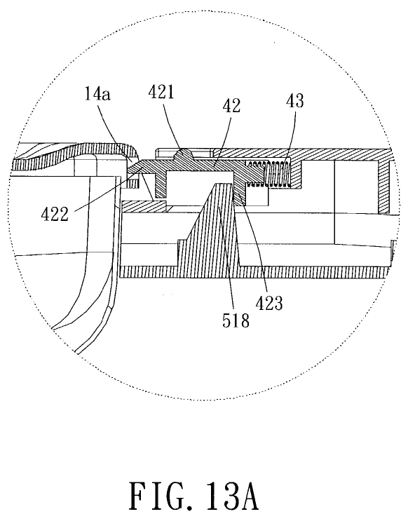

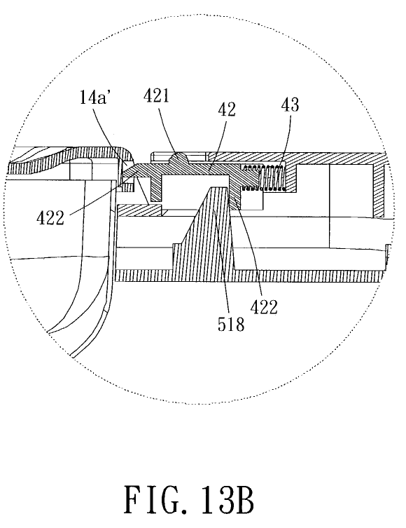

Referring to FIGS. 12 and 13, a snapping device 4 is installed in the electric pan for the convenience of detaching or replacing the baking plate, such that multi-functions can be achieved. The first and second handles 11 and 51 each has a pair of snapping devices 4 for installing the first and second baking plates 14 and 54, respectively. Each of the snapping devices 4 includes a receiving seat 41, a snapping structure slidably installed in the receiving seat 41, and a resilient member 43 installed at the end of the snapping structure 42 to provide a restoring force. The receiving seats 41 are disposed in the first and second handles 11 and 51, respectively. The snapping structure 42 includes a push block 421, a smooth flange 422 to snap with the first and second baking plates 14 and 54, and a lower blocking plate 423 blocked by each of the blocking members 118 and 518 of the first and second handles 11 and 51. The first and second baking plates 14 and 54 each further comprises a pair of bores 14a and 54a allowing the snapping devices 4 to engage therewith. The bores 14a and 15a can also be replaced by the recessed slots 14a′ and 15a′.

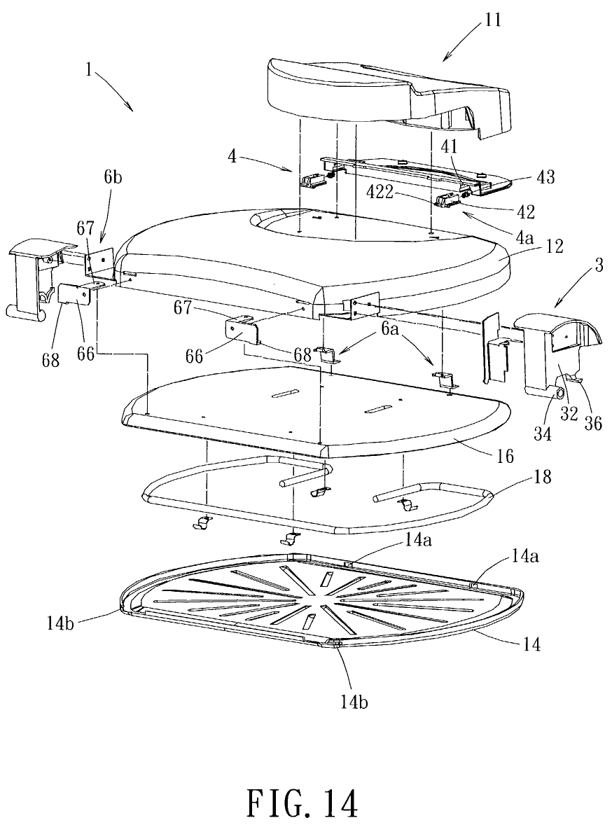

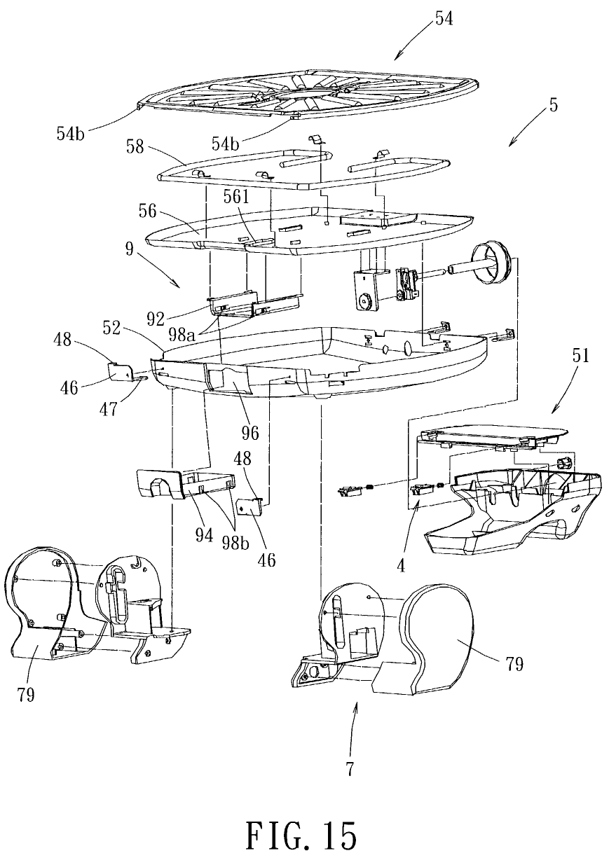

Referring to FIGS. 14 and 15, the first and second shells 12 and 52 each further comprises a front holding sheet 6a and rear holding sheet 6b for holding the first and second heat isolating plate 16 and 56, respectively. The front holding sheet 6a is used to hold the front edges of the first and second heat isolating plates 16 and 56. Each of the rear holding sheet 6b comprises an intermediate plate 66 connected to the first and second shells 12 and 52, a top plate 67 mounted to the top of the intermediate plate 66 to connect the rear edges of the first and second heat isolating plates 16 and 56, and a lower plate 68 mounted to the bottom of the intermediate plate 66 to snap with the first and second baking plates 14 and 54. The first and second baking plates 14 and 54 each has a slot 14b, 54b allowing the lower plates 68 of the rear holding sheets 6b to snap therewith.

The electric baking pan also has the liquid or oil collecting function. Referring to FIG. 2, the second baking plate 54 is a oil-collecting baking plate and comprises a plurality of radially distributed protruding ridges 541, a circular raised ring 542 protruding from the center, a circular trench 543 at a periphery of the circular raised ring 542, and front and rear elongate trenches 544 and 545 extending forward and rearward from the circular trench 543. The surface of the second baking plate 54 is inclined downward from the edge to the center thereof. The elongate trench 545 is inclined downward from the center to the edge, and has an oil outlet 546 located at the lowest level. Therefore, the liquid on the second baking plate 54 flows towards the circular trench 543, through the rear elongate trench 543, and exits from the outlet 546.

Aligned with the outlet 546, a through hole 561 is formed on the second heat isolating plate 56, and an oil collector 9 is disposed for collecting the oil exiting from the outlet 546. The oil collector 9 is installed in the rear portion of the second shell 52. The oil collector 9 includes a U-shaped sliding seat 92 connected to the lower portion of the second heat isolating plate 56. An oil collecting box 94 is slidably disposed in the sliding seat 92, and an opening 96 is formed in the second shell 52 allowing the oil collecting box 94 to be withdrawn. The oil collector 9 may further comprises an anti-sliding device on the sliding seat 92 and the oil collecting box 94, which comprises a pair of nonslip chokes 98a at two sides of the sliding seat 92, and two nonslip slots 98b at two sides of the oil collecting box 94.

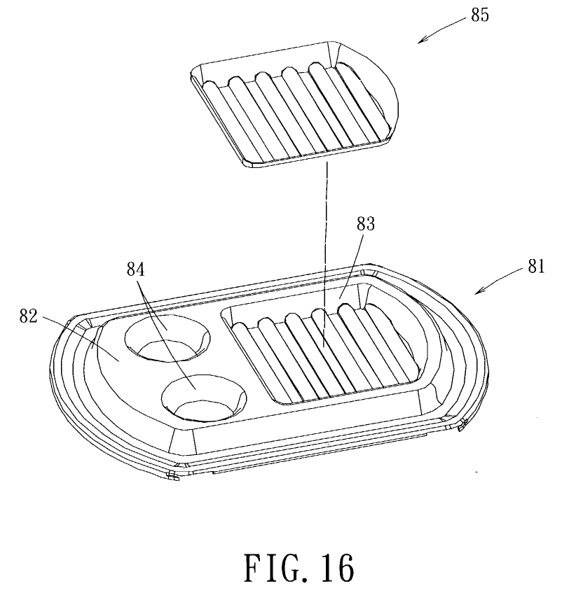

Referring to FIG. 16, the electric baking pan further comprises a detachable plate 8 disposed on the first or second base 1 or 5 for cooking breakfast. The breakfast plate has an elevated baking surface 82, a substantially rectangular recess 83 in the plate surface 82 for baking food, and a plurality substantially round recesses 84 for baking food such as eggs. The rectangular recess 83 may further comprise a toast plate 85 for baking toast.

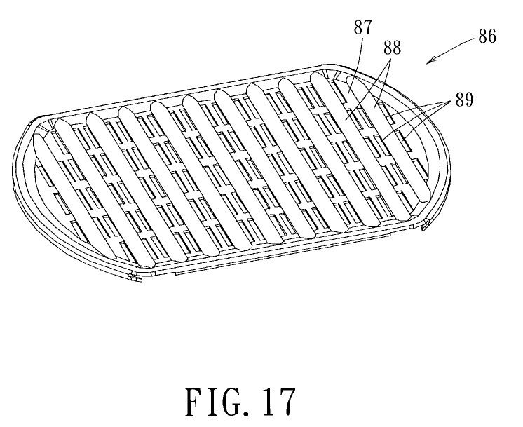

Referring to FIG. 17, the electric baking pan further comprises a detachable smokeless barbecue plate 86, which has a baking surface 87, a plurality of ridges 88 protruding from the baking surface 87, and a plurality of oil draining slits 89 at two sides of the ridges 88. The oil draining slits 89 are out of the position under which the heating element is installed. Therefore, for barbecuing meat, water is applied to heat isolating plate with a level lower than that of the heating element, such that the dripping oil is cooled down by the water to achieve the smokeless objective.

Therefore, the present invention achieves the functions and characteristics as follows.

The thick food is prevented from being deformed while being baked in the electric baking pan, and by inserting the ring between the first and second bases, the electric baking pan can be applied for baking skewers.

The baking plate is detachable, such that it can be easily cleaned. Further, the baking plate can be replaced by other plates with various patterns, such that the electric baking pan can be used to bake foods in various shapes.

This disclosure provides exemplary embodiments of a child safety blind. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

What is claimed:

1. An electric baking pan, comprising:
a first base, including a first shell, a first handle connected to one side of the first shell, a first baking plate, at least one snapping device installed in the first handle to engage with the first baking plate, a pair of pivot plugs disposed at two lateral ends of the first shell, and a first heat isolating plate disposed in the first shell, the first heat isolating plate includes a first heating element to heat up the first baking plate; and
a second base, including a second shell, a second handle connected to one side of the second shell, a second baking plate, at least one snapping device installed in the first handle to engage with the first baking plate, a pair of pivot sockets disposed at two lateral ends of the second shell allowing the pivot plugs slidably installed therein, and a second heat isolating plate disposed in the second shell, the second heat isolating plate includes a second heating element to heat up the second baking plate;
wherein the first base can be placed on top of, elevated over, perpendicular to, or extending in parallel with the second base.

2. The electric baking pan according to claim 1, further comprising a ring inserted between the first base and the second base.

3. The electric baking pan according to claim 2, wherein the ring has a surrounding sidewall and a plurality of hanging elements on the sidewall.

4. The electric baking pan according to claim 1, wherein the first and second handles each has a pair of snapping devices, each of which further comprises a receiving seat, a snapping structure for snapping the first and second baking plates, and a resilient member connected to a rear end of the snapping structure.

5. The electric baking pan according to claim 4, wherein the first and second baking plates each has a pair of front holding sheets and a pair of rear holding sheets for holding the first and second heat isolating plates.

6. The electric baking pan according to claim 5, wherein the first and second baking plates each comprises a bore or a slot at the position where the snapping device and the holding sheets connect together.

7. The electric baking pan according to claim 1, wherein the pivot plugs each comprises a panel connected to the first shell, a pivot pin and a positioning lever mounted on the panel; and
each of the pivot sockets comprises a substrate connected to the second shell, an elongate ring and a U-shaped lug fixed on the substrate, the elongate ring further comprises a rear side panel and a front side panel, the front side panel has an opening, while the rear side panel has a slot aligned with the opening, such that the pivot pins of the pivot plugs are slidably installed in the elongate ring, and the positioning levers of the pivot sockets are disposed in the elongate ring or the U-shape lug.

8. The electric baking pan according to claim 1, further comprising an oil collecting plate, including a plurality of radially distributed ridges, a circular raised ring protruding from a center thereof, a circular trench at a periphery of the circular raised ring, a front and a rear elongate trenches extending forward or rearward from the circular trench, wherein the oil collecting plate is inclined downwardly from an edge to the center thereof, and the rear elongate trench is inclined downwardly from the center to the edge and has an oil outlet at the bottommost part thereof.

9. The electric baking pan according to claim 8, wherein the second shell includes an oil collector therein, the oil collector comprises a through hole formed on the second heat isolating plate and aligned with the oil outlet, a sliding seat disposed under the second heat isolating plate, an oil collecting box slidably installed in the sliding seat, and an opening formed on the second shell allowing removal of the oil collecting box.

10. The electric baking pan according to claim 1, further comprising a detachable breakfast plate, including a baking surface, a substantially rectangular slot recessed from the baking surface, and a plurality of round slots recessed from the baking surface, wherein the rectangular slot may further comprises a toast plate thereon.

11. The electric baking pan according to claim 1, further comprising a detachable smokeless plate, including a baking surface, a plurality of ridges raised from the baking surface, and a plurality of oil drainages at two sides of the ridges, wherein the oil drainages are formed out of the place under which the heating elements are installed, and water is applied over the first or second heating element to cool down the oil dripped thereon immediately.
